(19) United States
(12) Patent Application Publication
(10) Pub. No.: US 2006/0026601 A1
(43) Pub. Date: Feb. 2, 2006

(54) Executing commands on a plurality of processes

(76) Inventor: David George Solt JR., Frisco, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/902,239

(22) Filed: Jul. 29, 2004

(51) Int. Cl. G06F 9/46

(52) U.S. Cl. 719/313

(57) ABSTRACT

A processor-based method involves executing commands on a distributed computing arrangement. A plurality of processes of the distributed computing arrangement are selected on which to execute the commands. The commands are sent to the selected plurality of processes. In response to the commands, a respective response from each of the selected processes is received. Each response has an arrival time. The responses are aggregated into groups based on similar characteristics of the responses. One or more of the groups are selected for display based on comparing the arrival times associated with the responses of the selected groups with a timeout value. For each selected group, a message is displayed representative of responses in the selected group.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present disclosure relates to computing systems, and in particular to executing commands on parallel processing systems.

### BACKGROUND

High-performance computing refers to the systems used to solve large and complex computational problems. These complex problems arise in applications such as nuclear weapons research and creating high-resolution weather models. Typically, high-performance computing requires specialized, high-performance hardware, such as supercomputers, that drive massively paralleled central processing units (CPUs). For many years, supercomputers were the predominant hardware used to run massive calculations.

Although effective, supercomputers are expensive and require specialized skills to set up and operate. In order for an organization to make use of supercomputers, significant hardware investments are required, as well as hiring specialized programmers and administrators. However, recent advances in technology have provided alternate means of performing high-performance computing that is far less expensive than traditional supercomputers.

One of the new approaches to high-performance computing involves the use of clusters. Clusters are simply standalone computers that are networked together into a massively paralleled processor (MPP) systems. Each computer runs independently and solves part of a distributed computation. The availability of cheap but powerful personal computers combined with fast networking technologies has made clustering as effective as supercomputers in solving large computational problems, but at a far cheaper price. The availability of open and freely modifiable operating systems such as Linux™ has allowed clustering to be more easily implemented by the average organization.

Although clustering has been instrumental in providing inexpensive MPP, the management of clustered systems is not trivial. Administering hundreds of independently running computers poses many challenges, including physical aspects (heat removal, access for maintenance, etc.) and system administration tasks (setting up machines, checking status, etc). A variety of approaches for addressing these and related issues may therefore be desirable.

### SUMMARY

A processor-based method involves executing commands on a distributed computing arrangement. A plurality of processes of the distributed computing arrangement are selected on which to execute the commands. The commands are sent to the selected plurality of processes. In response to the commands, a respective response from each of the selected processes is received. Each response has an arrival time. The responses are aggregated into groups based on similar characteristics of the responses. One or more of the groups are selected for display based on comparing the arrival times associated with the responses of the selected groups with a timeout value. For each selected group, a message is displayed representative of responses in the selected group.

### BRIEF DESCRIPTION OF THE DRAWINGS

FIG. 1 illustrates a distributed processing system according to embodiments of the present invention;

FIG. 2 illustrates a processing arrangement for sending commands to a plurality of processes according to embodiments of the present invention;

FIG. 3 illustrates an example of aggregated outputs according to embodiments of the present invention;

FIG. 4 illustrates a buffer used for aggregating output according to embodiments of the present invention;

FIG. 5 illustrates moving grouped data from the buffer to a printable queue according to embodiments of the present invention; and

FIG. 6 illustrates a flowchart for grouping data for display in accordance with embodiments of the present invention.

### DETAILED DESCRIPTION

In the following description of various embodiments, reference is made to the accompanying drawings which form a part hereof, and in which is shown by way of illustration various example manners by which the invention may be practiced. It is to be understood that other embodiments may be utilized, as structural and operational changes may be made without departing from the scope of the present invention.

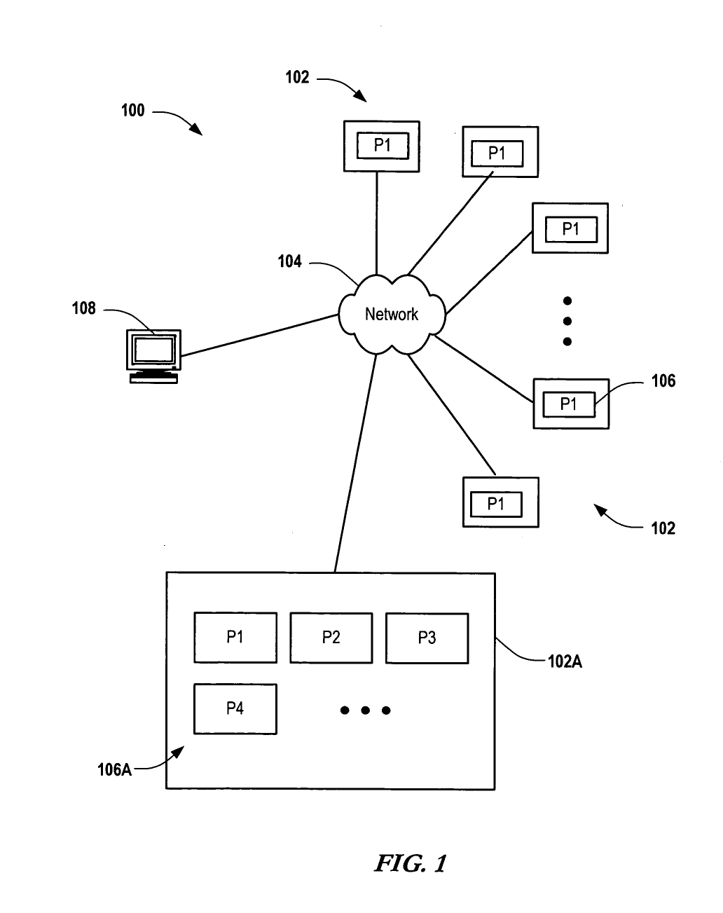

In general, the present disclosure relates to executing commands on a plurality of processes. The processes may be running on the same or different computers, and are generally able to receive commands from a central location. For example, FIG. 1 shows a distributed computing system 100 according to embodiments of the present invention. The distributed computing system 100 may include various computers 102, 102A coupled via a network 104. Each of the computers 102, 102A has at least one process running that is part of a distributed computing task, as represented by process 106. Computers may also have multiple processes running as part of the distributed computing task, as represented by processes 106A in computer 102A. The processes 106, 106A may be any computing task capable of receiving a command, including kernels, shells, applications, virtual operating systems, etc.

The commands sent to the processes 106, 106A may be issued from a workstation 108 that is coupled to the cluster via the network 104. The commands may be related to the distributed computing task and/or the commands may be part of routine system administration of the computers 102, 102A. The workstation 108 may be a controller node for the cluster system 100, or the workstation 108 may be a participant in the cluster.

The execution of commands on multiple processes generally involves two aspects: sending the commands to multiple machines, and determining the results of those commands. Most operating systems have mechanisms for sending text commands via a network or other communications link. Computers typically run a server process that is configured to accept connections and receive the commands. Numerous servers and protocols have been developed for remotely executing commands, including telnet, remote shell (rsh), secure shell (ssh), etc. Although sending a single command using these mechanisms may be fairly straightforward for the user, it quickly becomes unmanageable if the user has to repeat this hundreds of times. Therefore, in a distributed computing arrangement, a way is needed to simultaneously send the command to all processes (broadcasting) or a subset of the processes (multicasting).

Even if a mechanism exists for multicasting or broadcasting commands to multiple processes, it may be difficult to determine the results of the commands. It will be appreciated that even a command that has a fairly simple output (e.g., a single line of text) can still be overwhelming if received simultaneously from hundreds of processes. Therefore, the return values should be presented in a form that reduces the total amount of data received, yet still conveys the information needed by the user.

The sending and receiving aspects of controlling multiple interactive processes are related because, for reasons of efficiency, the command should be sent in parallel and the corresponding results should also be received in parallel. However, the sending and receiving aspects can also be dealt with separately, since some scenarios may not require sending commands or receiving results. For example, it is still useful to be able to broadcast a command that produces no output to multiple machines. Similarly, an application that is view-only, such as viewing debug messages, can benefit from techniques used to simplify the return values of simultaneously executed commands. Therefore, the sending or invoking of commands will be described first, followed by various techniques for processing the return values of those commands.

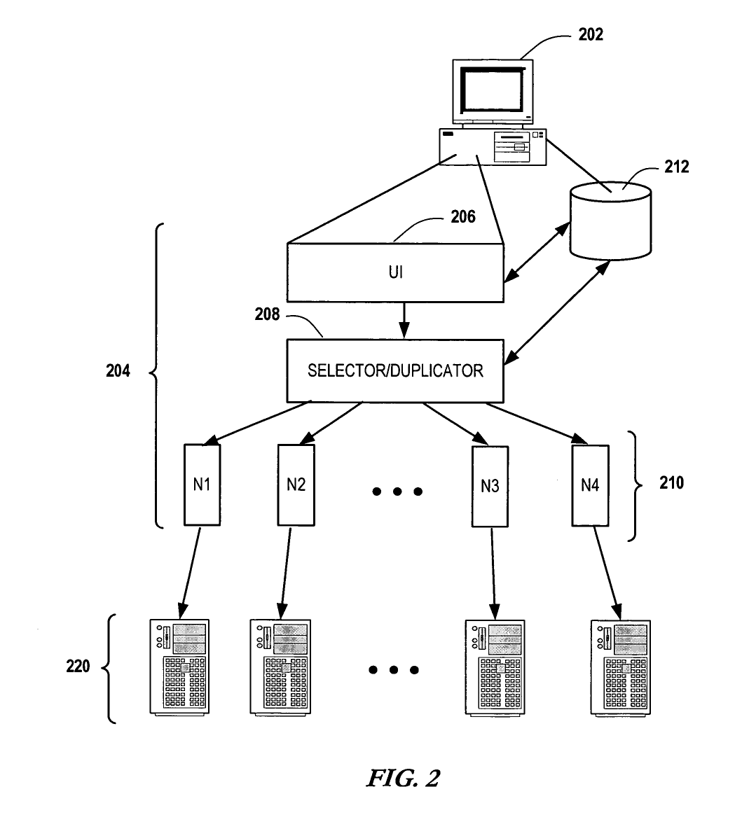

Turning now to FIG. 2, a diagram illustrates how commands can be sent to and/or invoked on a plurality of processes according to embodiments of the present invention. The command is generally issued on a user-accessible computing arrangement 202. The computing arrangement 202 may include user input/output devices (e.g., keyboard, monitor) for accepting input and displaying output, as well as processing elements (e.g., CPU, memory, etc.) for performing functions involved with sending commands. The computing arrangement 202 may be contained in a single unit (e.g., workstation) or be part of a networked computing arrangement (e.g., client-server arrangement).

The computing arrangement contains software 204 for sending commands targeted for a plurality of processes, as represented by the computers 220. It will be appreciated that the computers 220 may be separate devices, each having one or more target processes. In other arrangements, the computers 220 may include a single device simultaneously running multiple processes.

The software 204 includes a user interface (UI) component 206, a selector/duplicator component 208, and a plurality of connection components 210. The software components 206, 208, 210 may have access to a persistent data store 212 for storing preferences, reading input data, logging, and the like.

Typically, the user enters commands at the user interface component 206. Based on the form of these commands and/or user preferences, the selector/duplicator component 208 selects destination processes for the commands. The selector/duplicator 208 is connected to the connection components 210 for sending the commands and receiving the responses. The connection components 210 each handle the particulars of connecting to an associated destination process.

The connector components 210 may use unique connections methods depending on the arrangement of the computers 220. For example, a subset of the computers 220 may be running on a trusted network, therefore the connector components 210 associated with those computers 220 may use remote shell (rsh). For computers 220 that are on untrusted networks, the associated connector components 210 may utilize secure shell (ssh).

The selector/duplicator component 208 may be configurable via the UI component 206 to select processes and/or computers 220 that are targeted to receive the commands. The processes may be identified by any combination of machine identifier, process identifier, last response received, previous response received, etc. The user may interact with the selector/duplicator component 208 via the UI component 206 to create a target set of processes for each command.

For example, the user may wish to see if a certain process called “foo” is running all computers 220. The user may use a command such as “ps-ef|grep foo|grep-v grep” to determine whether the process is running, and through the selector/duplicator component 208 have this command sent to all computers 220. In this example, it may be assumed that all but ten of the computers 220 returned a response text (e.g., “root 3373 3209 0 14:32 pts0 foo”) indicating that the command is running. However, nine of the computers 220 just return a linefeed (indicating the process is not running), and one computer 220 did not respond at all. The user may select the nine computers 220 that returned a linefeed and direct a command (e.g., “start_foo”) to those machines to restart the dead process. The one non-responsive machine may be sent a reboot command, assuming it will still respond to a software initiated reboot.

The user may issue commands via the software 204 using any user interface known in the art. In one arrangement, the UI component 208 can utilize a command line interface. In such an arrangement, the user is provided with a prompt where a command string can be entered. For example, assume the UI component 208 is invoked via a command line program called “ippi,” which stands for “interactive parallel process interface.” The “ippi” command may be configured to execute parallel commands using a substitution file. The substitution file can be used to generate individual instances of the command string. The parallel processes thus created are determined through the combination of the substitution file and the command. An example syntax of the “ippi” command is shown in Listing 1.
ippi[options]-f substitution_file base-command Listing 1

The base-command is modified using information in the substitution_file. One process is started for each line in the substitution_file. Each new process is formed by taking the base-command and replacing all occurrences of the string “%h” with the corresponding line of the child file. An example command is shown in Listing 2. Listing 3 shows the contents of /tmp/child_file.

Listing 2

ippi -f /tmp/child_file -c “/bin/mv -i %h %h.bak”

Listing 3

/tmp/child_file:

/tmp/foo
/tmp/bar
/tmp/baz

The command in Listing 2 will parse the file shown in Listing 3, thereby causing the three commands to be spawned shown in Listing 4.

Listing 4

/bin/mv -i /tmp/foo /tmp/foo.bak
/bin/mv -i /tmp/bar /tmp/bar.bak
/bin/mv -i /tmp/baz /tmp/baz.bak

Other substitution strings may be used in the command line similar to the “%h” substitution strings. For example, various substitutions can be made based on data related to the destination processes and computers 220. This data may include hostname, Internet Protocol (IP) addresses, process id, parent id, terminal id, etc. These destination-specific values may be substituted in the base-command by the selector/duplicator component 208 and/or the connector components 210.

Although the illustrated example utilizes a command line interface, it will be appreciated that the UI component 206 may be adapted other human or machine interfaces. For example, the “ippi” command may have input and output text redirected via pipes or files. Another process having a graphical user interface (GUI) may be adapted to communicate with the “ippi” command via these redirections. In other configurations, the UI component 206 may be designed as a pure GUI application without command line access.

During the presentation of data by the UI component 206, the user may determine that one or more processes require input from the user in order to proceed. In the examples presented below, a command-line UI component 206 is assumed, although it will be appreciated that similar functionality may be incorporated into a graphical UI. When user input to processes is required, the UI component 206 may allow the user to press a key to receive a prompt, from which a variety of useful commands are available. When the user is given the prompt, all available output is displayed so that the user has the most up-to-date view of the processes' states. Additional processes output may be held until the user leaves the prompt and returns to monitoring mode.

From the prompt, the user may be provided access to commands of the form: [where test] command. Legal commands include:

status—print the status of the selected processes;

send string—send the specified string to the selected processes;

interact—places user in direct interaction with the selected process. A replay of the processes last n lines of output is displayed for context. If multiple processes are selected, the user is sequentially placed in interaction with each.

kill—terminate the selected processes.

Legal tests in the above command prototype may include:

process=id—select the single processes with numeric identifier id.

last=string—select the processes whose last output matches string.

contains=string—select the processes whose output contains string.

The omission of a test implies that all processes are to be selected. Through this simple interface, the user has the ability to manage many interactive processes with relative ease.

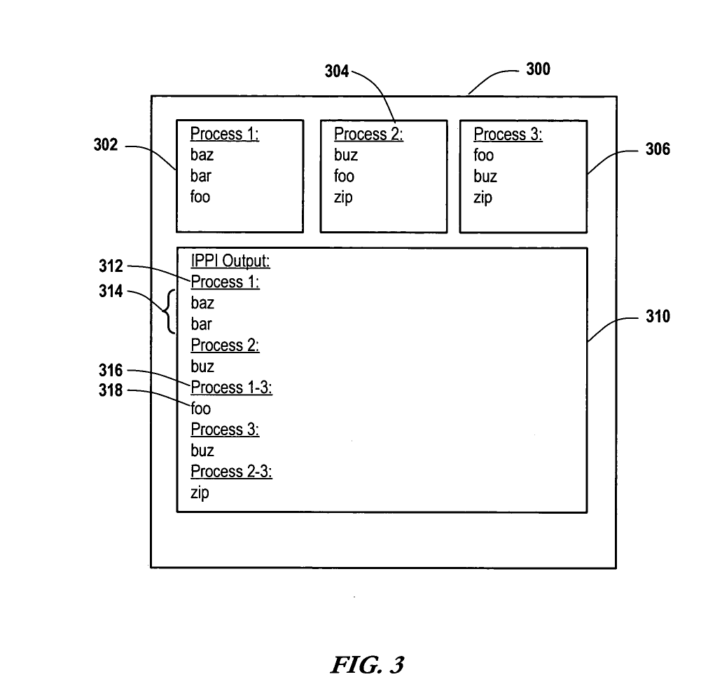

The user may access these commands via the UI component 206. If the UI component 206 utilizes a command line interface, then the results of the commands may be summarized and displayed as text. If the UI component 206 uses a GUI, the summarized results may be shown as any combination of text and graphics. The diagram 300 of FIG. 3 shows an example of summarized results according to embodiments of the present invention. The diagram 300 assumes that one or more commands have been simultaneously sent to three processes, 302, 304, 306, which the system has labeled “Process 1”, “Process 2”, and “Process 2,” respectively. The boxes representing the processes 302, 304, 306 contain the aforementioned identifying labels along with return text of the command for the process. The summarized output is shown in box 310.

The summarized output 310 includes group headings (e.g., headings 312 and 316) and lines of output lines associated with the group headings (e.g., lines 314 and 318). Any similar output received by multiple processes is redundant and can be aggregated into groups. For example, the text “foo” was received by processes 302 and 306 and is shown as a single instance line 318. In general, the redundant data in the group is represented in the summarized output 310 by a form of output representative of members the group.

Where the redundant data is identical, as is the case in FIG. 3, then any member of the group can be shown to represent the group. It may also be the case that the output is similar, such as the “root 3373 3209 0 14:32 pts0 foo” output resulting from the “ps” command discussed above. It is very likely that no two instances of the “foo” process have the same process id on any of the nodes. However, the user does not need the process id just to see if the process is still running. The summarized output 310 may be configured to deal with such a case by showing the identical portions of the command, and representing the different portions with a replacement character. In the “ps” example, the output from all the responding nodes may be presented as “root **** **** 0 **:** *** foo,” where the “*” characters act as placeholders for the differing data. The user may also have the option to have the differing data presented as well. For example, the differing data could be shown in subgroups listed under the main grouping. The subgroups may be ordered by process id or other characteristics.

By grouping similar command responses in the output 310, the user can quickly determine the results of a large number of simultaneously executed commands. This is especially true where the results contain a large amount of redundant data. Although the output lines 314, 318 in this example are grouped by process id, other groupings may be used (e.g., machine identifier, last response received, previous response received, etc). The output lines 314, 318 are generally printed so as to preserve the actual order in which the lines 314, 318 were received. By preserving the order of results, it can be assumed that lines 314 came in prior to line 318.

The actual output 310 produced may vary depending on the timing of output produced by the processes 302, 304, 306. The algorithm that forms the groups shown in the output 310 may be tuned to provide a compromise between text output delay and the sizes of the groups containing redundant information. It will be appreciated that the larger the groups can be made, the more compact the summary presented to the user. However, if the display of output waits too long to aggregate redundant data, then the user will be forced to wait to view the output, which also may be unacceptable.

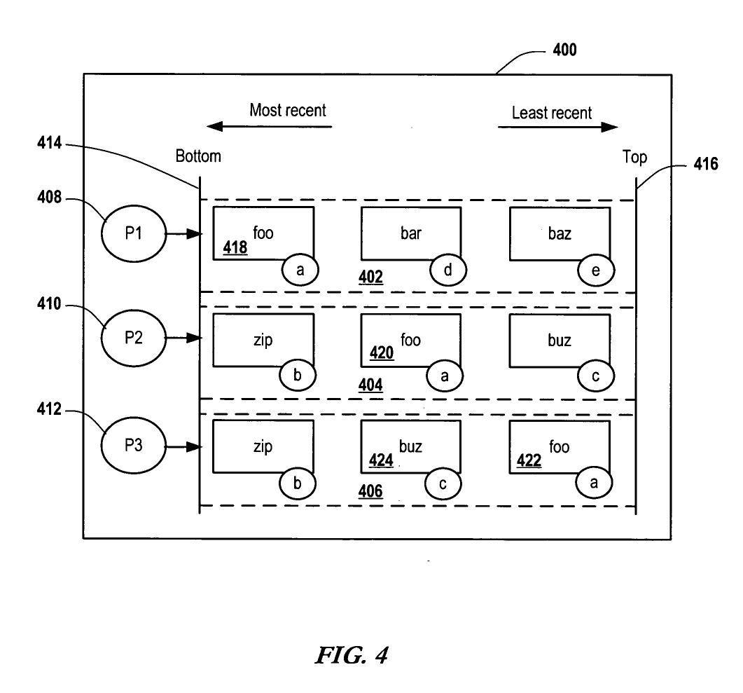

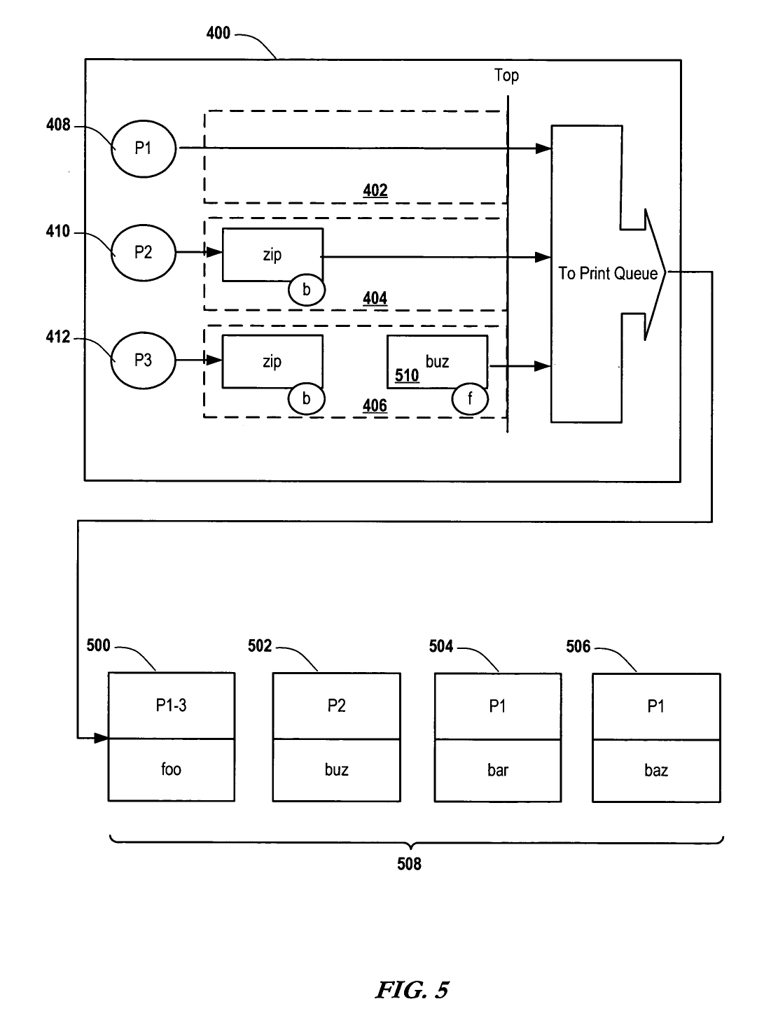

Example techniques of aggregating redundant data according to embodiments of the present invention are shown in FIGS. 4 and 5. For this example, it will be assumed that process output is summarized on a per-line basis. The principles described herein may also be applicable to other bases of summarization, such as by tokens/words, character groups, n-tuples, etc. In FIG. 4, a buffer arrangement 400 is shown that can be used to temporarily store process output for aggregation. The buffer arrangement 400 includes stream buffers 402, 404, 406 that are associated with processes 408, 410, 412, respectively. It will be appreciated that the buffer arrangement can be adapted to contain any number of stream buffers associated with any number of processes. The stream buffers may be adaptable to include any number of elements.

The stream buffers 402, 404, 406 are typically formed as first-in, first-out queues. The data output from the processes 408, 410, 412 is inserted into the stream buffers 402, 404, 406 at the bottom 414 of the buffer arrangement 400, and data is removed for further processing from the top 416 of the buffer arrangement 400. While data is held in the buffer arrangement 400, an algorithm is used to search for the optimal presentation of the parallel data streams. This generally involves grouping similar data that is currently contained in the buffer arrangement 400.

As the processes 408, 410, 412 generate new output, the output is placed at the bottom 414 of the respective stream buffers 402, 404, 406. As each new piece of output (e.g. line 418) is added to the stream buffer 402, 404, 406, the new data 418 can be 1) associated with a previous grouping containing matching data; or 2) used as the basis for a new group with the new data 418 as its only member. The new data 418 should not be added to a grouping already containing a member from the same process. In such cases, the new data 418 is associated with a new grouping.

In the illustrated example, if line 418 were the newest piece of data, the algorithm would recognize that line 418 matches lines 420 and 422 of group “a.” Therefore line 418 is placed in group “a.” If the stream buffer 402 already had a data element that matched line 418, then a new group (e.g., group “f”) would be created.

The logic used to keep track of current groupings as described above may be included with the buffer arrangement 400, or provided by some other programmatic element that has access to the data in the buffer arrangement 400. At any given time, the buffer arrangement 400 includes zero or more groups of matching output data. The illustrated example has five groups (“a” through “e”) in the buffer arrangement 400. When the buffer arrangement 400 has at least one group, then it must then be determined when to remove the groups for display.

In one embodiment, the display of data removed from the buffer arrangement 400 is dynamic, because the data is displayed in response to an interactive user session. This may involve removing data from the buffer arrangement 400 at regular intervals for display. In one arrangement, an algorithm for removing groups from the buffer arrangement 400 may utilize an adjustable timeout value to control data removal from the buffer arrangement 400.

In some arrangements, a system call or separate thread of execution can be used to provide a timer function checking the buffer arrangement 400. After a timeout value has elapsed, the timer function checks the buffer arrangement 400 to determine if there are any non-empty stream buffers 402, 404, 406. If any of the stream buffers 402, 404, 406 contain data, then at least one group can be selected for display. Groups may be maintained in two categories: printable groups and nonprintable groups. Printable groupings are ordered and can be displayed in order to form an accurate representation of the process output they represent. Non-printable groupings are unordered and do not necessarily form a coherent view of the data streams they represent until they are transferred to the printable set of groups.

The groups shown in FIG. 4 are in non-printable form. As new output is read from the processes, 408, 410, 412, the outputs are placed in the respective stream buffers 402, 404, 406 and associated with a grouping. Groupings should be displayed carefully in order to preserve the actual ordering of the individual processes' outputs. For example, displaying all of grouping “c” to the user (in particular output line 424) would be erroneous because it would fail to indicate that previous output of process 412 included output line 422.

Groupings can be classified by depth. The depth of an element in a stream buffer 402, 404, 406 is the element's distance from the top 416 of its stream buffer queue. The depth of a grouping is the combined depth of its member stream buffer elements. Groupings are removed one at a time from the buffer arrangement 400 by selecting, from the groupings with the fewest members, the grouping with the least depth. This selection approach tends to preserve larger groups and also gives maximum opportunity for stream buffers 402, 404, 406 to be formed into larger groupings as the processes 408, 410, 412 produce further output.

As groupings are removed from the buffer arrangement 400, some members of the group may not be at the top 416 of their respective stream buffer. The data in these groups cannot be queued for display because there is older output in the stream buffer that has not yet been selected for display. In these cases, the grouping are split into printable members and non-printable members. The non-printable members are left in the buffer arrangement 400 and are associated with a new, distinct group.

The process of removing printable groups from the buffer arrangement 400 is shown in FIG. 5. The printable groups 500, 502, 504, and 506 are each represented by a box with the group identifier in the top half of the box and a representative text in the bottom half of the box. The printable groups 500, 502, 504, and 506 are taken from the buffer arrangement 400 and placed in the printable queue 508. The removal order of the printable groups 500, 502, 504, 506 is based on their position and the size of their associated grouping. In some cases, such as the “buz” group (shown as group “c” in FIG. 4), a non-printable grouping is split in order to maintain the original ordering. In this case, a new “buz” group, labeled group “f”, is created with a single member 510.

Once printable groups 500, 502, 504, 506 are transitioned to the printable queue 508, they may be further optimized for minimizing presentation output. For example, groups that have identical process sources can often be displayed at the same time. Printable groups with identical sources (e.g., groups 504 and 506) can be displayed at the same time as long as the intervening grouping's source sets do not intersect with the source set of the target groupings. The greater the length of the printable queue 508, the more opportunity there may be for such combinations.

The more stream buffers 402, 404, 406 that are collected, the greater opportunity for forming useful groupings. The more printable groupings 500, 502, 504, 506 formed before printing, the more opportunity for displaying multiple groupings at the same time. These goals are balanced with the goal of keeping the user current on the status of the interactive processes being executed. To maintain this balance, the algorithm shown in Listing 5 may be used for updating these structures.

Listing 5

while true {
.

for each process {

Streams.readProcessOutput(process);

}
if (Streams.lengthSmallestStream( ) > BUFFERSIZE −

force_factor) {

grouping := Streams.removeBestGrouping( );
PrintableGroups.Enqueue(grouping);

}
if (PrintableGroups.Length( ) > BUFFERSIZE−

force_factor) {

grouping := PrintableGroups.Dequeue( );
PrintableGroups.

displayCompatibleGroupings(grouping);

force_factor := 0;
timer:= currentTime( );

if (Streams.lengthLargestStream( ) == 0) {

force_factor := 0;
timer:= currentTime( );

}
if (currentTime( ) > timer + TIMEOUT) {

force_factor++;
timer:= currentTime( );

}

}
© 2003 Hewlett-Packard Company

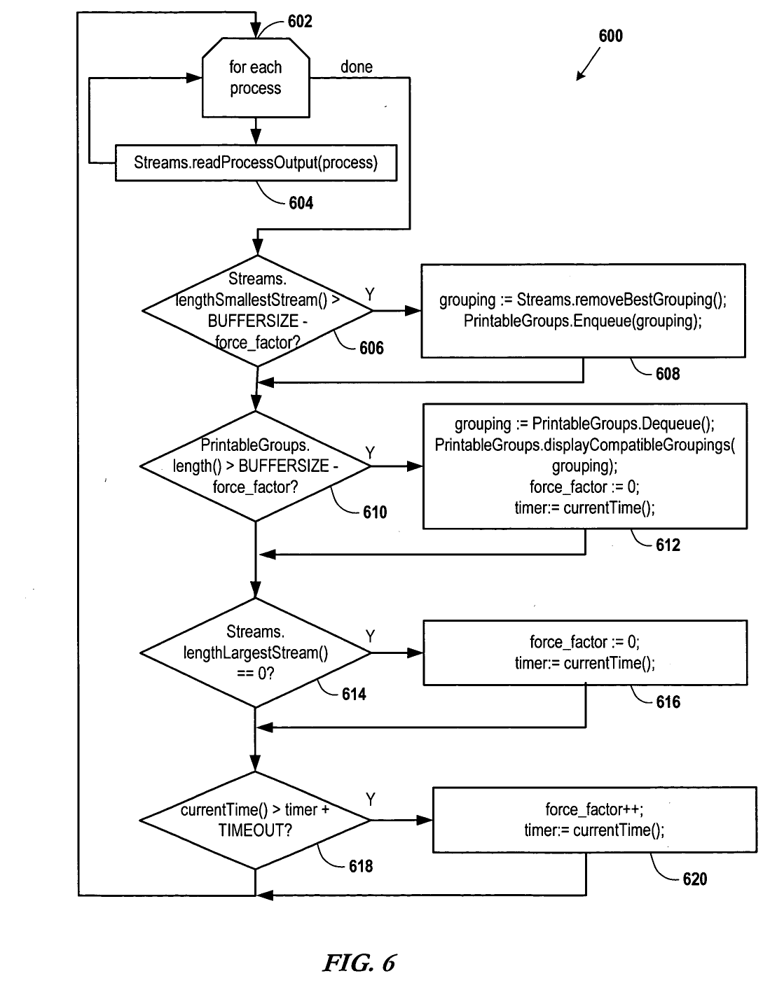

The algorithm shown in Listing 5 is also shown in FIG. 6 as a flowchart 600 according to embodiments of the present invention. The algorithm 600 begins by reading (604) new output into stream buffers for each process (602). The groupings formed by these stream buffers are moved from streams into printable groupings (608) whenever the length of the smallest stream is greater than the constant BUFFERSIZE minus a force factor (606). When printable groups are larger than a predetermined value (610), the groups are displayed (612). The force factor is reset to zero whenever data is displayed (612) or there are no queued stream buffers (614, 616). The force factor is increased (620) periodically while there are undisplayed stream buffers, as determined by checking a timeout value (618).

The algorithm 600 will display groupings (612) whenever the length of the printable groupings queue exceeds BUFFERSIZE minus the force factor (610). The BUFFERSIZE value is also used when removing groupings from the stream buffers (606, 608). In practice, the two uses of BUFFERSIZE could be represented by two separately tunable values. However, experience has shown that a BUFFERSIZE value of around 20 works well for both removing groupings from stream buffers and displaying groupings.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

It will be appreciated that processor-based instructions for implementing embodiments of the invention are capable of being distributed in the form of a computer readable medium of instructions and a variety of other forms. The description herein of such processor-based instructions applies equally regardless of the particular type of signal bearing media actually used to carry out the distribution. Examples of computer readable media include media such as EPROM, ROM, tape, paper, floppy disc, hard disk drive, RAM, and CD-ROMs and transmission-type media such as digital and analog communications links.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A processor-based method of executing commands on a distributed computing arrangement, comprising:
selecting a plurality of processes of the distributed computing arrangement on which to execute the commands;
sending the commands to the selected plurality of processes;
receiving, in response to the commands, a respective response from each of the selected processes, each response having an arrival time;
aggregating responses into groups based on similar characteristics of the responses;
selecting one or more of the groups for display based on comparing the arrival times associated with the responses of the selected groups with a timeout value; and
displaying for each selected group a message representative of responses in the selected group.

2. The method of claim 1, wherein sending the commands to the selected plurality of processes further comprises:
forming a base command having one or more substitution placeholders;
reading a plurality of substitution values configured to replace the substitution placeholders;
replacing the substitution placeholders of the base command with the substitution values to form a plurality of commands specific to the selected plurality of processes; and
sending the plurality of commands to the selected plurality of processes.

3. The method of claim 2, wherein forming the base command further comprises forming the base command with a reference to a data file containing the substitution values.

4. The method of claim 2, wherein the substitution values comprise a plurality of data entries, each data entry specific to a process of the selected plurality of processes.

5. The method of claim 1, further comprising, after receiving the respective response from each of the selected processes, placing each response on a buffer associated with the process from which the response was received.

6. The method of claim 5, wherein selecting groups for display further comprises selecting for display groups that have the fewest responses, and wherein the responses of the selected groups are closest to a removal end of the buffers.

7. The method of claim 1, wherein the similar characteristics comprise equivalencies of the responses.

8. The method of claim 1, wherein selecting the plurality of processes comprises selecting the plurality of processes based on a respective process identifier of the plurality of processes.

9. The method of claim 1, wherein selecting the plurality of processes comprises selecting the plurality of processes based on a return value of a previous command executed on the plurality of processes.

10. The method of claim 1, wherein the distributed computing arrangement comprises a clustered computing arrangement.

11. The method of claim 1, wherein the responses comprise lines of text.

12. A processor-readable medium, comprising:
a program storage device configured with instructions for causing a processor of a data processing arrangement to perform the operations of,
selecting a plurality of processes of a distributed computing arrangement on which to execute one or more commands;
sending the commands to the selected plurality of processes;
receiving, in response to the commands, a respective response from each of the selected processes, each response having an arrival time;
aggregating responses into groups based on similar characteristics of the responses;
selecting one or more of the groups for display based on comparing the arrival times associated with the responses of the selected groups with a timeout value; and
displaying for each selected group a message representative of responses in the selected group.

13. The processor-readable medium of claim 12, wherein sending the commands to the selected plurality of processes further comprises:
forming a base command having one or more substitution placeholders;
reading a plurality of substitution values configured to replace the substitution placeholders;
replacing the substitution placeholders of the base command with the substitution values to form a plurality of commands specific to the selected plurality of processes; and
sending the plurality of commands to the selected plurality of processes.

14. The processor-readable medium of claim 13, wherein forming the base command further comprises forming the base command using a reference to a substitution file containing the substitution values.

15. The processor-readable medium of claim 13, wherein the substitution values comprise a plurality of data entries, each data entry specific to a process of the selected plurality of processes.

16. The processor-readable medium of claim 12, wherein the operations further comprise, after receiving the respective response from each of the selected processes, placing each response on a buffer associated with the process from which the response was received.

17. The processor-readable medium of claim 16, wherein selecting groups for display further comprises selecting for display groups that have the fewest responses, and wherein the responses of the selected groups are closest to a removal end of the buffers.

18. The processor-readable medium of claim 12, wherein the similar characteristics comprise equivalencies of the responses.

19. The processor-readable medium of claim 12, wherein selecting the plurality of processes comprises selecting the plurality of processes based on a respective process identifier of the plurality of processes.

20. The processor-readable medium of claim 12, wherein selecting the plurality of processes comprises selecting the plurality of processes based on a return value of a previous command executed on the plurality of processes.

21. The processor-readable medium of claim 12, wherein the plurality of processes comprise processes running on a clustered computing arrangement.

22. An apparatus comprising:
means for selecting a plurality of processes of the distributed computing arrangement on which to execute the commands;
means for sending the commands to the selected plurality of processes;
means for receiving, in response to the commands, a respective response from each of the selected processes, each response having an arrival time;
means for aggregating responses into groups based on similar characteristics of the responses;
means for selecting one or more of the groups for display based on comparing the arrival times associated with the responses of the selected groups with a timeout value; and
means for displaying for each selected group a message representative of responses in the selected group.
